(19) United States
(12) Patent Application Publication
(10) Pub. No.: US 2009/0248844 A1
(43) Pub. Date: Oct. 1, 2009

(54) Hybrid Profile Management for Electronic Social Networks

(75) Inventors: Dieter M. Sommer, Zurich (CH); Samuel Muller, Zurich (CH)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/059,864

(22) Filed: Mar. 31, 2008

(51) Int. Cl. G06F 15/173

(52) U.S. Cl. 709/223

(57) ABSTRACT

In the context of electronic social networking platforms, ‘hybrid profile’ management allows a user u to create and locally manage ‘pseudo-profiles’ reflecting the profile information of real-world contacts who are not actual members of the networking platform. The first-degree electronic social network of a given user u thus includes both the profiles of other regular network users who have agreed to be direct contacts to u as well as these pseudo-profiles.

### BACKGROUND OF THE INVENTION

1. Field of the Invention

This invention relates to the management of information in electronic social networking platforms.

2. Description of Background

Current electronic social networking platforms (ESNPs) enable their users to describe and manage their personal profile information (such as name, phone number, private and business e-mail addresses, etc.) and to ‘connect’ their profile to the profiles of other users of the network. Thereby the users get access to each other's profile information and each user only manages her own profile information. In existing ESNPs, however, a user can only ‘connect’ to user profiles of members of a given platform. If a real-world person A is not a member of a given ESNP, his real-world friends, who may be member of one or many ESNPs, have to manage A's contact information manually, e.g., in an old-fashioned address book, and thereby run the risk of losing contact by forgetting about the person, not being notified of changed contact information, etc. This creates significant management overhead.

### SUMMARY OF THE INVENTION

The present invention overcomes this problem by using ‘hybrid profile management’ for electronic social networks. Using hybrid profile management a user u of an ESNP can create and locally manage ‘pseudo-profiles’ reflecting the profile information of real-world contacts who are not actual members of the networking platform. The first-degree electronic social network of a given user u thus includes both the profiles of other regular network users who have agreed to be direct contacts to u as well as these pseudo-profiles. To ensure strong privacy, pseudo-profiles are typically only accessible to the user who created and manages them.

If a person A at some point joins an ESNP as a new member, then all existing users of the ESNP who have created and managed pseudo-profiles reflecting A's profile information may obtain an integrated view on the pseudo-profile and profile. This conceptually means a merge of the two and may involve linking pseudo-profile items to profile items in order to keep the pseudo-profile up-to-date.

Existing users may also extend their profiles by adding pseudo-profile information to them. This mechanism provides for the full integration of pseudo-profile and profile information. By default, this pseudo-profile information is only visible to the user u who has added the information. User u may make this pseudo-profile information accessible to the respective owner of the profile to which the information was attached. User a has a fully integrated view of the self-managed pseudo-profile information and the profile information.

The profiles of existing users can be extended by adding pseudo-profile information to them. This is relevant when the access control policy changes for u or when the relationship with the other user is getting terminated by either of the users.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

The overall system helps users save time in managing their contacts and prevents the ongoing proliferation of tools and systems associated with ESNPs.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates the relationship between ESNP-based profile information and pseudo-profile information according to the present invention.

FIG. 2 illustrates the merger of information from an ESNP-based profile and from a pseudo-profile.

FIG. 3 illustrates the termination of a relationship with another ESNP user and shows how relevant profile information can be preserved and subsequently managed in a pseudo-profile.

The detailed description explains the preferred embodiments of the invention, together with advantages and features, by way of example with reference to the drawings.

### DETAILED DESCRIPTION OF THE INVENTION

In the present invention, a user It creates and manages ‘pseudo-users’ with ‘pseudo profiles’ reflecting the profile information of real-world contacts who are not members of a given ESNP or who refuse to accept a contact request. Like ordinary profile information, pseudo-profile information may include both personal information (attributes of arbitrary types) and contact information of the particular pseudo-user U′. In the same spirit, a user u may chose to extend the profile information of existing users (contacts or non-contacts) with structured pseudo-profile information. By default, the pseudo-profile information is only accessible to the user u who has created this information and manages it, thereby ensuring the privacy of the respective users.

This kind of hybrid profile management is missing in today's ESNPs leading to a strong defragmentation of electronic social networking data and a proliferation of tools and platforms used by each user. Our invention avoids this data defragmentation and platform/tool proliferation and thus makes the managing of one's social network electronically much easier and comfortable.

### 1. Users

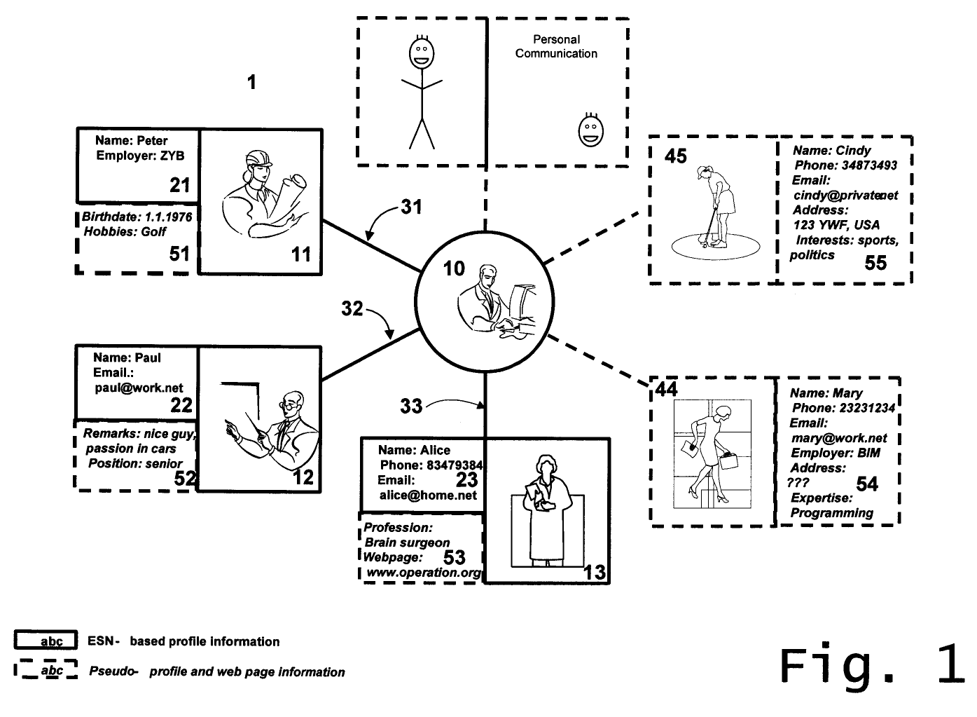

Referring to FIG. 1, the ESNP 1 comprises a set of users U={u1, u2, . . . } where the actual subset of active system users is finite. A user can be a human being, a software agent, an avatar (as used in virtual worlds), or any sort of computer-representable actor. Each user 10, 11, 12, 13 has a profile 21, 22, 23 associated and typically wants to share some specific subset of the information in his profile with selected other users in the network.

### 2. Relationship, Contacts, and Personal Network

Users 10, 11, 12, 13 can establish relationships 31, 32, 33 to other users. We let O⊂U×U be the set of relationships between users. If a user aεU has a relationship to a user u′εU, we have that (u, u′)εO. Note that because the relation O is symmetric, we also have (u′, u)εO. We then say that user u′ is a contact of user u, and vice versa. The relation O contains a tuple (u, u′) if and only if the two parties have mutually agreed to enter a relationship by executing some protocol (e.g., user u requests to add user u′ to his contact list and user u′ accepts this request).

Users u and u′ who have a relationship (i.e., the tuple (u, u′) is in the relation O) are said to belong to each other's personal networks. Furthermore, if (u, u′)εO, u′ is said to be a contact of u.

### 3. Regular Profile Information

A user's profile 21, 22, 23 consists of his personal information (i.e., attributes) and his contacts, where an attribute aᵢ is a tuple (name, type, value), with a name like “Skillset”, an associated data type like “listofstrings”, and a value like “[Java, C++]”. An attribute can, for example, be of type multi-valued attribute, string, boolean, or integer. The invention does not constrain the types. A contact of a user a is another user u′. Contacts can be de-referenced (navigation of the contact) so that the de-referenced contact's profile information can be accessed. De-referencing a contact u′ of a user u requires accessing profile information of u′.

Let the set A={a₁, a₂, . . . } denote the set of all attributes of the system. Let Aᵤ⊂A denote the set of the attributes of the user u.

Let the set Uᵤ⊂U be the set of contacts of the user a. We have that Uᵤ:={u′|(u, u′)εO}. That is, the contacts are expressed by the set of users u has a relationship with.

Let Iᵤ=Aᵤ∪Uᵤ with Aᵤ⊂A and Uᵤ⊂U be the regular information of user u known by the system, that is, the user u's regular profile information. This information is the information that is available to other users, but restricted through an access control solution such as, for example, rating-based access control.

### 4. Pseudo-Users and Pseudo-profile Information

A user u 10 may chose to create and manage a finite set of pseudo-users 44, 45 Pᵤ={u₁, . . . , uₖ}⊂U and according pseudo-profile information 54, 55 PIᵤ_{ₖ}_{,u}=Aᵤ_{ₖ}_{,u}∪Uᵤ_{ₖ}_{k,u} for each such user uₖ. Likewise, a user u may associate pseudo-profile information 51, 52, 53 PI_{u′,u}=A_{u′,u}∪U_{u′,u} with some existing user u′ 11, 12, 13. We let PI_{u′}=∪_{uεU}PI_{u′,u} be the set of all pseudo-profile information about a user u′.

### 5. Accessible Profile Information

Let the infinite but countable set Z={read, write, delete, delegate, execute, . . . } contain the different types how regular and pseudo-profile information can be accessed. The present invention does not constrain the elements of the set Z by our invention.

Some access control function, e.g., ∫: U×U×C→Pow((Iᵤ∪PIᵤ)×z) normally governs which subset of the profile information and the pseudo-profile information of it another user u′ may access in which way. The result set I_{u,u′}εPow((IᵤU PIᵤ)×Z) is the profile information of user u that u′ can access, as determined by the access control function. Accessing a data item can, for example, be reading it, writing it, deleting it, or executing an arbitrary operation. The set I_{u,u′} contains tuples from (IᵤÅPIᵤ)×Z. For example. I_{u,u′}{(a₁, read), (a₄, write), (u″, read)} defines that u′ may read a] of u, write a4 of u, and read contact u″ of u. That is, the set I_{u,u′} defines in a fine-grained way what u′ may access of u; by default, a user u is granted at least read and write access to the pseudo-profile information PI_{u′,u} of any user u′.

Thus, user u can access the hybrid pseudo-profile information set I_{u′,u} about user u′. The complete profile information of user u′ accessible to user u is called hybrid because it includes a subset of the regular profile information I_{u′} which is managed directly by the user u′ and also all the structured pseudo-profile information PI_{u′,u} about u′ as created and locally managed by user u.

### 6. Consolidated View on Pseudo-Profiles and Profiles

Recall that, informally speaking, the access control function operates on the items of the profile and pseudo-profiles for u′ user u′ together and allows access to a subset of them for a user u. A consolidated view on those items is required. The three cases below require specific consideration as they can potentially lead to situations that need further consideration. More precisely, such a situation arises if attributes of the same type are contained in the profile and pseudo-profile and both being visible (readable) to u. This situation needs to be managed in order to give u an appropriate user experience of profile integration.

1) A user u′ joins the network. We assume that the user u′ and the pseudo-user u″ that u holds a pseudo-profile for refer to the same person. A matching of a user, for example u, and a pseudo-user, for example u″, can be determined by a heuristic matching of the attributes. Identifying attributes such as email, phone number, or combinations involving name and address are useful for this matching. The matching is done by the server and the user is given a suggestion to link the pseudo-profile of u″ with the profile of u′. This suggestion can contain a list of possible people in case of an ambiguous matching.

In this case, user If could be notified by the ESNP in case user u′ joins the network and u′ and the pseudo-user u″ match. Then user u may get proposed to request establishing a relationship with u′. In the case when it establishes a new pseudo-profile u″ and the ESNP finds an existing user u′ who matches u″, the same notification applies. In this case it may also happen that multiple matching users get displayed and it is left to u to decide which one to potentially initiate a relationship with.

2) A relationship between u and u′ is established.

3) Profile information of u′ becomes accessible to u (this can, for example, be by changes of the access control policy through u; this can be related also to u′ adding new profile items that are immediately accessible by u).

All the cases 1) to 3) above have similar semantics. More precisely, the pseudo-profile for u′ (or u″ if a pseudo-user has been created) needs to be integrated with the profile of u′ in the view of u whenever new profile information of u′ becomes accessible by u. This can lead to the situation that a pseudo-profile data item needs integration with a profile data item for u′.

### 6.1 Cases

Data items of the pseudo-profile or profile can be attributes or contacts without loss of generality. The presented examples in no way limit the general applicability of the invention.

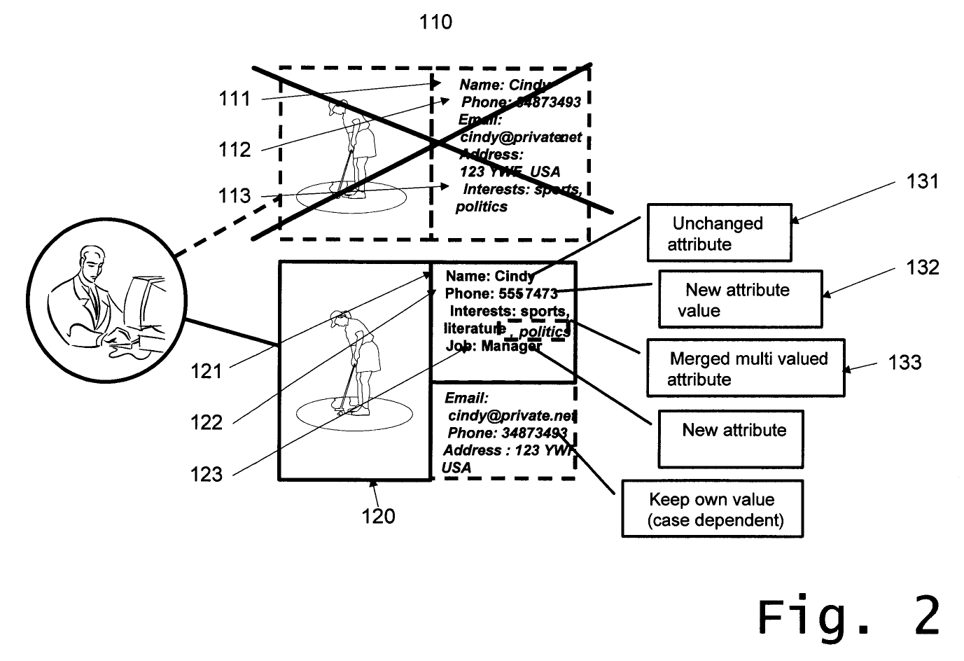

Referring to FIG. 2, if a pseudo-profile 110 data item has the same value as the corresponding profile 120 data item—for example, the ‘name’ pseudo-attribute for u′ 111 has value ‘Cindy’ and the ‘name’ profile attribute for u′ 121 has value ‘Cindy’—the user u should only get to see one of the attributes 131. This can be realized by either of the following:
The access control policy could be changed in a way that the user only gets read access to one of the attributes. Then only one of the attributes gets displayed.
The system displays only one of the attributes while not updating the access control policy, that is, having access to both of the attributes. This can be done by a component for integrating pseudo-profile and profile information.

If a pseudo-profile data item has a different value as the profile data item the user u gets to see both attributes. Optionally, he may be challenged to hide one of the attributes, maybe temporarily. Depending on the attribute semantics this may make sense only for the user to decide.

Alternatively, if a pseudo-profile data item has a different value as the profile data item—for example, the ‘Phone’ pseudo-attribute for u′ 112 has value ‘34873493’ and the ‘Phone’ profile attribute for u′ 122 has value ‘555-7473′—the user a gets to see only one of the attributes 132. This can be subject to an automated decision depending on the attribute type. Formal semantics can, for example, be expressed using an attribute ontology.

If pseudo-profile data item has a different value as the profile data item, the decision of whether the user gets to see both or only one of the attributes can be handled by a component for integrating pseudo-profile and profile attributes. The cases could also be realized through the access control function.

In the case of multi-value attributes, if the pseudo-profile data item has a different value as the profile data item—for example if the ‘Interests’ pseudo attribute 113 is ‘(sports, politics)’ and the ‘Interests’ attribute 123 of the profile is ‘(sports, literature)’—the user u gets to see an integration of the attributes. This can be done by merging the attribute values. For the above example, the hybrid attribute ‘Interests’ 133 would then have the value ‘(sports, literature, politics)’.

In any of the cases of pseudo-profile and profile integration, all attributes of the pseudo-profile may be kept in a history record.

Pseudo-profile information may also be readable by u′ when u sets the access control rules accordingly.

### 6.2 Transfer of Management Responsibility

The above-discussed integration of pseudo-profile and profile information can be complemented with a transfer of management responsibility for pseudo-profile information from a user u who initially created some pseudo-profile information PI_{u′,u} (or PI_{u″,u} in case of a pseudo-user) about some user u′ (or pseudo-user u″) to the user u′. This requires the following tasks: a) adaptation of the access control policy; b) linking data items (attributes or contacts) of the pseudo-profile with data items of the profile.

a) Such a transfer would thus, from an access control policy perspective, typically mean that a user u transfers his write rights for the pseudo-profile information to user u′ and while keeping the read rights using some rights transfer operation like transferRights: Pow(PIᵤ×Z)×U×U→Boolean, which transfers the rights from a user u who initially created the pseudo-profile information to the respective user u′ whom the profile concerns.

b) The pseudo-profile items whose access rights have been transferred will be linked with the corresponding attributes in the profile of u′. That is, write operations to the profile attribute are propagated to the pseudo-attribute, and thus the pseudo-profile information is automatically updated. This can be realized using an event-based system for triggering the updates.

The idea behind this kind of management of pseudo-profile information is to keep the pseudo-profile up-to-date. This helps in case of termination of the relationship as then there is no need to manually update the pseudo-profile by u.

### 7. Terminating a Relationship

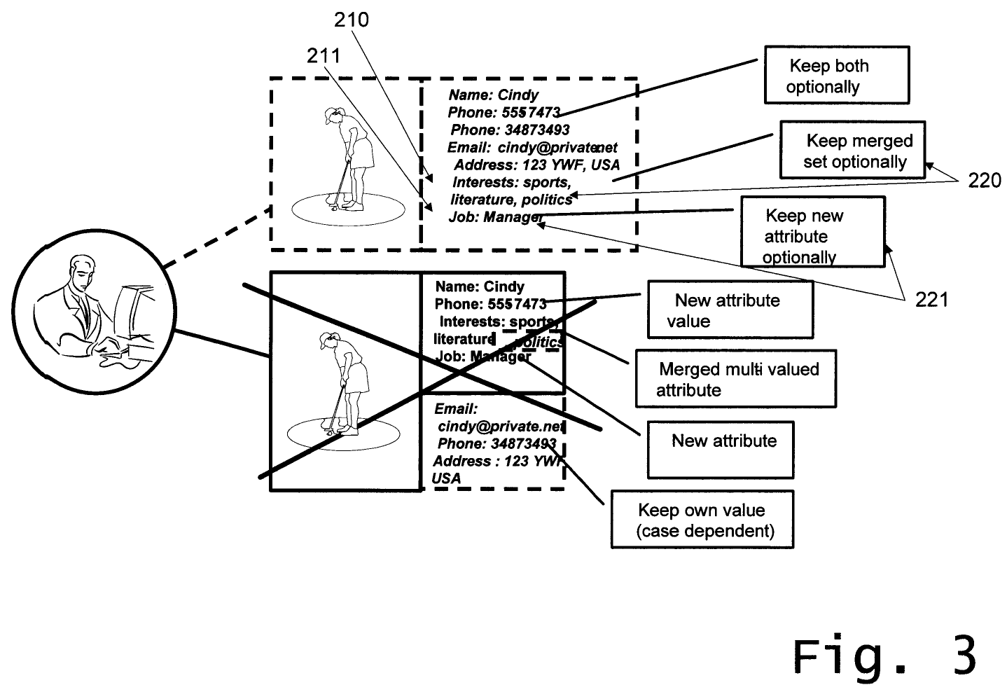

Referring to FIG. 3, when a user u and u′ decide to terminate their relationship (assume, u′ terminates), the basic idea is to revoke the access rights of a to the profile of u′. This is not sufficient though, as the pseudo-profile PI_{u′,u} that u has had for u′ before establishing the relationship with u′ needs to be recovered or redisplayed. There are multiple options how to accomplish this:
The pseudo profile PI_{u′,u} is restored as was before establishing the relationship. This does not account for any changes in attributes that have been carried out afterwards. Thus, the solution is not ideal for it.
The latest values from I_{u′} that it can read are synchronized to PI_{u′,u} for attributes that have originally been in PI_{u′,u}. This gives u the latest values for those attributes and is fair in the sense that u gets the information that he would have otherwise probably managed anyway in his pseudo-profile for u′. For example, for the ‘Interests’ pseudo-attribute 210 the integrated value of ‘(sports, literature, politics)’ 220 is synchronized. This can be done by asking u on whether to update the attributes in the pseudo-profile.
User u might also delete all profile and pseudo-profile information when terminating the relationship as the latter could imply that there is no more interest in the other person.

For the case when u does not have access to data item a of u′ any more, a new pseudo-data-item a′ could be created that resembles the most recent value of a—for example, a new pseudo-data item ‘Job’ 211 could be created with the pseudo-data value ‘Manager,’ 221 reflecting the most recent value of ‘Job’ that u could was able to access of u′. This is quite challenging from a privacy and data protection legislation point of view. This does not only apply to a termination of a relationship, but any case when profile information is not accessible by u any more.

When profile information gets non-accessible to u, the access right for u′ to the pseudo attributes of u concerning u′ and the coupling to the profile attributes must be removed. If u′ leaves the ESNP, the pseudo-profile must be re-associated to the pseudo-user u″.

When u′ terminates the relationship, this never leads to a deletion of the pseudo-profile of u unless u decides to do this.

### EMBODIMENTS OF THE INVENTION

Embodiments of the invention set forth herein may take many forms, and the functionality associated with the method of the present invention may reside on the server side, on the client side, or some combination of both. For example, in one preferred embodiment, the ESNP implements the functionality of the invention. In another preferred embodiment, the majority of the functionality resides on the client side and is associated with the client's address books. A third preferred embodiment combines the first two embodiments, where pseudo-profile information is managed on client systems. The present invention is not limited to the aforementioned paradigm, however, and may, for example, be implemented in a completely different paradigm, e.g., a setting that employs the concept of multi-party computation between the server(s), clients, and third parties.

In the first preferred embodiment, the system is a distributed system that uses a client-server paradigm. The server is preferably implemented using the J2EE or Net frameworks. Data is stored using a DB2 or other relational database system. A client solution based on a Web interface as usual for social networks in order to keep the entrance barrier as low as possible is preferred. Web 2.0 technology such as AJAX (asynchronous JavaScript) is preferably used for creating a best possible user experience in a browser-based application.

In this embodiment, the majority of the functionality of the present invention is typically implemented on the server, particularly the access control function. The pseudo-profile information PI_{u′,u} is managed remotely by the server. Server managed pseudo-profiles have the advantage of independence of the user's client system and also of being managed by the ESNP operator. Disadvantages are the resulting trust model of an ESNP operator that needs to be trusted for all data and also the fact that the ESNP is a single point of failure that is not under the control of the users. From a privacy point of view the situation that the server manages the pseudo-profiles, that is, data provided by users without consent of the data subjects may not be feasible.

In the second preferred embodiment, clients have local address books, and thus a big part of the overall functionality resides on the client side. A light-weight server could connect the users such that the local address book of a user is used for updating the profile of the user that gets accessible to other users. Thus, the data management would be completely decentralized and the server would act as a cache and a distribution point for profiles. This system is an extension of the address book paradigm towards electronic social networks and thus provides a contrary view to extending a social network system with address book functionality.

The third preferred embodiment is an approach between the two extremes. We can manage the pseudo-profiles on the client as an extension to the server's functionality, and all other profile information on the server as in traditional electronic social networks. Client-managed pseudo-profiles have a confidentiality and trust model advantage: The information of the pseudo-profiles is not known by the ESNP operator and thus the operator does not need to be trusted for keeping them confidential. This can be important for a small number of key contacts or attributes, e.g., ones that are vital for u's business and thus u is reluctant to disclose them. Client-managed pseudo-profiles require in the setting of a server implementing most of the functionality that the clients have a plugin for their Web browser that allows for handling the pseudo-profile data. The plugin would transparently merge for display the accessible profile information I_{u′} of a user u′ with locally-managed pseudo-profile items PI_{u′,u} for user u′ as specified in the invention. The plugin would also keep the pseudo-profile up-to-date. The use of client-side functionality allows for decoupling pseudo-profile information from profile information from a data management view.

### Conclusion

We have defined a method for integrating a user's locally managed pseudo-profile information with the profile information of users of ESNPs and for managing pseudo-profiles of non-users of the ESNP or users that have no established relationship with the user. Our invention provides the user with an integrated view on those two different classes of information and helps streamline his contact management.

This system greatly improves the utility that ESNPs provide to their users as they can now manage both member users and non-members in an integrated way. This helps minimize the proliferation of a plethora of tools for managing people's profiles and provides optimal integration of mechanisms to reduce the management overhead incurred by the users.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for managing information regarding both users and non-users of one or more electronic social networks comprising:
providing an interface through which a user u of one or more electronic social networks can manage contacts with one or more other users U of the one or more electronic social networks with whom said user u has established relationships through the one or more electronic social networks;
allowing user u to use said interface to manage contacts with one or more real-world contacts who are not members of the one or more electronic social networks by providing u with the ability to create and manage one or more pseudo-profiles reflecting the contact information of the one or more real-world contacts who are not members of the one or more electronic social networks; and
allowing user u to create and manage one or more pseudo-profiles corresponding to the one or more other users U of the one or more electronic social networks with whom said user u has established relationships through the one or more electronic social networks, said pseudo-profiles containing additional and/or different information regarding the one or more other users U of the one or more electronic social networks with whom said user u has established relationships through the one or more electronic social networks.
